(19) United States
(12) Patent Application Publication
(10) Pub. No.: US 2005/0252049 A1
(43) Pub. Date: Nov. 17, 2005

(54) Business card with wrapper containing soap leaves

(76) Inventor: Daniele Dudler, Riva S. Vitale (CH)

Correspondence Address: YOUNG & THOMPSON, 745 SOUTH 23RD STREET, 2ND FLOOR, ARLINGTON, VA, 22202, US

(21) Appl. No.: 10/524,148

(22) PCT Filed: Jan. 29, 2003
(86) PCT No.: PCT/IB03/00270

§ 371 Date: Feb. 11, 2005

(30) Foreign Application Priority Data
Aug. 14, 2002 (CH) 1398/02

(51) Int. Cl. G09F 1/00

(52) U.S. Cl. 40/124.01

(57) ABSTRACT

A description is given of a business card (1) made of card or platic material, in which the edges (4, 5, 6, 7) are folded towards the “verso” (1v) and are shaped in such a way as as to form an openable wrapper (2) containing in its interior one or more soap leaves (3i).

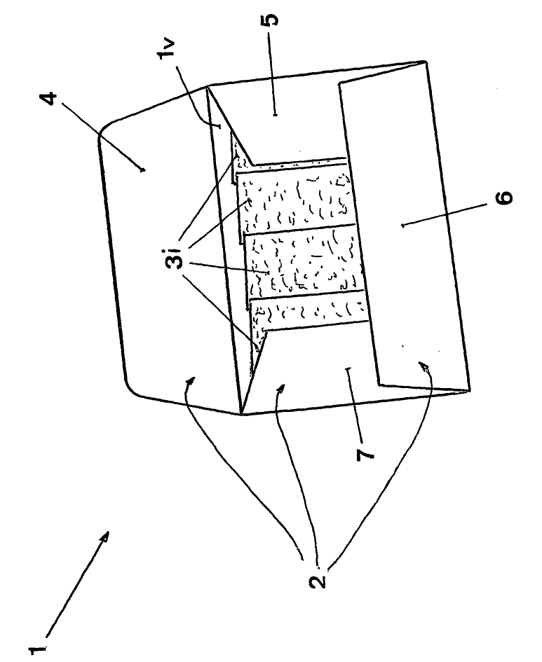

The present invention relates to the printing industry, and in particular to the production of business cards.

As is well known, the “recto” side of a business card is printed with the desired information, such as names, addresses, business activity, etc., the business card being left with interested persons to remind them of this information.

The utility of a business card is therefore reduced to its “reminder” function, but more often than not, being such a commonplace item, it is put in a drawer then soon forgotten about.

The inventor of the present innovation felt that the business card needed features that would make it useful and pleasant to keep in a wallet and encourage the recipient to make such use of it, rather than putting it away in a drawer.

For this purpose he has devised the business card of the present invention which, as will be seen clearly later, functions as a pocket “soap holder” and diffuses a pleasant light perfume.

The edges of the business card of the invention are suitably shaped and folded towards the “verso” in such a way as to form an openable wrapper that contains in its interior one or more soap leaves of known type. The result is a business card not much thicker than an ordinary card, which, besides releasing a gentle fragrance from the soap contained inside it, can also be very useful when travelling, by providing one or more sheets of single-use soap that is lightweight and extremely compact, for attending to one's personal hygiene.

The subject of the invention is therefore a business card as described in the appended claim 1.

A more detailed description will now be given of a preferred illustrative embodiment of the invention, during which reference will also be made to the appended figure, which shows a perspective view of the “verso” of the said illustrative embodiment. As can be seen in the drawing, the business card 1 of the invention, the “recto” of which is not visible, being turned towards the paper on which the drawing itself appears, has its edges 4, 5, 6, 7 shaped suitably according to known methods used to construct an envelope, and folded towards the “verso” 1v in such a way as to form, when laid parallel to the actual business card 1, a wrapper 2 that can easily be opened and contains in its interior one or more leaves 3i of soap of known type.

To help to preserve the fragrance of the soap it is possible according to the inventor to apply spots of glue between the folded edges 4, 5, 6, 7, preferably a single spot situated in a position suitable for the purpose. The area and separate strength of the said spots of glue must be very limited to allow the wrapper 2 to be opened easily without being crushed when the user wishes to remove one of the said soap leaves. The latter should preferably be arranged in such a way that even if they overlap they do not make the business card 1 of the invention too thick.

The result is a business card whose weight and thickness are not very different from those of an ordinary card, and that acts as a portable travel soap holder and at the same time releases a gentle fragrance in the place (for example the wallet) in which it is kept. The objective of the inventor has thus been achieved, namely that of producing a business card having unusual functional features and which is therefore more likely to be kept and appreciated by its recipient.

1. Business card (1) made of card or plastic material, characterized in that its edges (4, 5, 6, 7) are folded towards the “verso” (1v) and are shaped in such a way as to form an openable wrapper (2) containing in its interior one or more soap leaves (3i).

2. Business card according to claim 1, in which its said edges (4, 5, 6, 7) are joined together by one or more spots of glue.
